(19) United States
(12) Patent Application Publication
(10) Pub. No.: US 2003/0136018 A1
(43) Pub. Date: Jul. 24, 2003

(54) Method and an apparatus for manufacturing a fiber web provided with a three-dimensional surface structure

(76) Inventors: Jeffrey Herman, Bala Cynwyd, PA (US); David A. Beck, Appleton, WI (US); Thomas Thoroe Scherb, Sao Paulo (BR)

Correspondence Address: TAYLOR & AUST, P.C., 142 S. Main St., P.O. Box 560, Avilla, IN, 46710, US

(21) Appl. No.: 10/056,489

(22) Filed: Jan. 24, 2002

(51) Int. Cl. F26B 11/02; D06F 58/00

(52) U.S. Cl. 34/114

(57) ABSTRACT

In a method for manufacturing a fiber web, in particular a web of tissue or hygiene material, provided with a three-dimensional surface structure, the fiber web is pressed at a dry content of <25% onto an imprinting fabric by means of a first pressure field and is thereby pre-imprinted and is subsequently once more pressed onto an imprinting fabric by means of a further pressure field for further dewatering and drying in order to fix the three-dimensional surface structure and strength. Moreover, the dry content is achieved by a favorably priced apparatus instead of by a TAD drying apparatus.

The invention relates to a method and to an apparatus for manufacturing a fiber web, in particular a web of tissue or hygiene material, provided with a three-dimensional surface structure. It further relates to a method and an apparatus for dewatering a fiber web, in particular a web of tissue or hygiene material.

The imprinting of a three-dimensional structure into the surface of a paper web, in particular of a tissue web, in particular of hand tissue, is known (see, for example, WO 99/47749, WO 01/18307). It is further known that a very good paper quality can be achieved by so-called through-air drying (TAD). However, it is disadvantageous that the use of TAD dryers is very complex and correspondingly expensive.

It is an aim of the invention to provide an improved method and an improved apparatus of the kind initially mentioned with which in particular a high quality of the end product can be achieved in an economic and correspondingly favorably priced manner even without the use of a larger TAD drying apparatus. In this connection, a corresponding quality should be reached in particular with respect to the water retention capability, the water absorption rate, the bulk, etc.

This object is satisfied in accordance with the invention by a method for manufacturing a fiber web, in particular a web of tissue or hygiene material, provided with a three-dimensional surface structure, in which the fiber web is pressed, e.g. sucked, at a dry content of <25% onto an imprinting band by means of a first pressure field, and is thereby pre-imprinted, and is subsequently once more pressed onto an imprinting band by means of a further pressure field for further dewatering and drying in order to fix the three-dimensional surface structure and strength.

As a result of this embodiment, a lasting three-dimensional surface structure is produced in the relevant fiber web, i.e. in particular in the relevant paper web, tissue web, or hygiene paper web, which is also present in the desired manner in the web, i.e. for example in the paper, even after the drying process. The use of a complex and correspondingly expensive TAD process is no longer required. In particular a lasting surface structure of, for example, of a tissue web or of a hygiene paper web can now also be produced downstream of the forming region or forming zone even without such a TAD drying apparatus.

An imprinting screen or an imprinting membrane is preferably used as the imprinting band (imprinting fabric) or structured band (structured fabric).

The fiber web is generally pre-imprinted downstream of the forming region.

It is of advantage in certain cases for the fiber web to be formed on the imprinting band used for the pre-imprinting. The fiber web can, however, also be transferred onto the imprinting band used for the pre-imprinting.

In accordance with a preferred embodiment, at least the first pressure field is produced by means of a suction element arranged on the side of the imprinting band remote from the fiber web in order to suck the fiber web into the surface structure of the imprinting band. In this connection, in particular a so-called wet suction box can be used as the suction element.

It is also of advantage for the fiber web to be pressed gently in the further pressure field, i.e. preferably over a stretch extended in the web running direction.

The further pressure field is preferably produced by means of a press nip. To effect the most gentle possible pressing of the web, this press nip can, for example, be produced between a dryer cylinder and an opposing element, with the fiber web guided through the press nip being in contact with the surface of the dryer cylinder and contacting the imprinting band with its other side. In particular a so-called Yankee cylinder can be used as the dryer cylinder. In particular a shoe press unit, which includes a flexible band guided via a press shoe in the region of the press nip, can be used as an opposing element interacting with the dryer cylinder, with a shoe pressing roll provided with a flexible roll jacket preferably being used as the shoe press unit. However, a press roll or a suction pressing roll can, for example, also be used as an opposing element interacting with the dryer cylinder.

A preferred practical embodiment of the method in accordance with the invention is characterized in that the pre-imprinted fiber web is dried on the dryer cylinder, or the Yankee cylinder, the fiber web is creped and/or the fiber web is subsequently wound up.

In accordance with a preferred embodiment of the method in accordance with the invention, the dry content at which the fiber web is pre-imprinted and/or the dry content at which the three-dimensional surface structure is fixed is selected in each case at <25%, in particular <15%, and preferably <10%. The water retention capability and the bulk, among other things, are thus lastingly increased, which means that the desired imprinting is also still present on the use of the end product, for example of a relevant web of tissue or hygiene material. In particular the advantage of a higher water retention capability for towel tissue (towel paper) is also still effective on the use of the relevant end product.

In accordance with a preferred practical embodiment of the method of the invention, a suction device is used between the suction element producing the first pressure field and the press nip producing the further pressure field and the fiber web is guided together with an imprinting band both over the suction device and through the press nip. It is of advantage in this connection if the suction device has a curved surface and if the fiber web and the imprinting band are guided over this curved surface. A suction roll can, for example, be used as the suction device.

Further advantages result on the use of a press shoe due to the relatively long press nip, since a better transfer of the fiber web to the Yankee cylinder is achieved over a longer stretch.

The imprinting band can in particular be guided via the suction element or the wet suction box upstream of the suction device, i.e. for example the suction roll, in order to suck the fiber web into the three-dimensional surface structure of the imprinting band and thus to imprint this structure onto the band. At the same time, the relevant suction element results in a corresponding increase in the dry content.

It is also of advantage for the length of the press nip of the shoe press including the dryer cylinder and the shoe press unit observed in the web running direction to be selected larger than a value of approximately 80 mm and for the shoe press to be designed such that a pressure profile results over the press nip length with a maximum pressing pressure which is smaller or equal to a value of approximately 2.5 MPa. A gentle pressing is thus ensured with which it is avoided that the structure produced in the fiber web, e.g. in the tissue web or in the hygiene paper web, is again smoothed out.

As already mentioned, a suction roll, with which a pressure hood is preferably associated, can, for example, be used between the suction element produced the first pressure field and the press nip.

In accordance with a preferred practical embodiment of the method in accordance with the invention, at least one dewatering screen with zonally different screen permeability is used in the forming region. The relevant dewatering screen can in particular be provided as an outer screen. A corresponding embodiment of the method is in particular of advantage in the manufacture of towel tissue. The screen produces a fine structure which increases the water absorbing rate and which provides an increased water retention capability in conjunction with the imprinting in accordance with the invention.

In certain cases, it is of advantage if a former with two circulating dewatering bands is used, which run together to form a pulp run in gap and are guided over a forming element such as in particular a forming roll, and if a dewatering screen with zonally different screen permeability is used as an outer band not coming into contact with the forming element and/or as an inner band. In this connection, an imprinting band can be used as an inner band, for example, and preferably a dewatering screen with zonally different screen permeability as an outer band. It is, for example, also possible for the fiber web preferably to be taken over from the inner band by an imprinting band.

In wet imprinting in a tissue machine provided with an imprinting band, it is in particular a question of achieving the desired dry content. The web can, for example, be wet imprinted by means of the imprinting band using a suction box upstream of the press. To now avoid the three-dimensional surface structure, which was pre-imprinted by the wet imprinting in the region of the wet suction box, being destroyed again by a short-term high pressure in the press nip, as is the case with a conventional suction press roll or press roll, in accordance with an advantageous practical embodiment of the method in accordance with the invention, there is guided through the press nip an imprinting band, e.g. an imprinting screen or an imprinting membrane, which is structured such that a smaller areal proportion of raised or closed zones results for this imprinting band in comparison with the areal proportion of recessed zones or holes and accordingly a smaller areal proportion of the fiber web is pressed in the press nip. The smaller areal proportion of raised or closed zones produces the web regions of high density for the strength, whereas the larger surface portion of recessed zones or holes, which remains at least substantially unpressed, provides the desired water absorption capability and the desired bulk such as has previously only been achieved by a complex and expensive TAD drying.

In this connection, an imprinting band can advantageously be used in which the areal proportion of raised or closed zones is ≦40% and preferably lies in a range from approximately 20 to approximately 30%, and in particular at approximately 25%.

An imprinting band is expediently used in which the raised zones and the recessed zones result through offsets, i.e. through intersections of picks and ends, of a screen cloth. As already mentioned, an imprinting membrane can, for example, also be used in which the raised and recessed zones result through the holes. It is of advantage in this case that 100% of the surface is pressed around the holes and a higher strength results.

The relevant imprinting band can again be guided together with the fiber web, for example, over a dryer cylinder, in particular a Yankee cylinder. In particular a shoe-pressing unit can again be used as the opposing element interacting with the dryer cylinder. The length of the press nip observed in the web running direction and the pressure profile resulting over the press nip length can also in particular be again selected such as was set down above.

It has been found that with the method in accordance with the invention, a water absorbing capability (g H₂O/g fibers) higher by 50% and a bulk (cm³/g) higher by 100% can be achieved with the same tensile strength when an imprinting band is used instead of a conventional felt in the press nip before the creping.

The water absorbing capability can be improved by up to 50% by creping the web and a water absorbing capability of TAD hand towel quality can be achieved by taking this circumstance into account.

The quality of the paper results as a consequence of the lower pressing of the web as a consequence of the smaller areal proportion of raised zones, and not due to a TAD dryer. The permeability of the web results from the stretching of the web into the cloth structure by means of the suction element, whereby so-called pillows are produced which correspondingly increase the water absorbing capability and the bulk. A relatively complex and correspondingly expensive TAD dryer is therefore no longer necessary for this.

The function of the TAD drum and of the through-air system consists of drying the web and, for this reason, the corresponding dry content must be achieved to be able to carry out the wet imprinting in a conventional machine, i.e. in particular in a conventional tissue machine.

To achieve the desired dry content, in accordance with a preferred embodiment of the method in accordance with the invention, at least one felt with a foamed layer is used for dewatering the web. In this connection, the foam coating can in particular be selected such that pores in a range from approximately 3 to approximately 6 μm result. The corresponding capillary action is therefore utilized for dewatering. The felt is provided with a special foam layer which gives the surface very small pores whose diameters can lie in the range set forth from approximately 3 to approximately 6 μm. The air permeability of this felt is very low. The natural capillary action is used for dewatering the web while this is in contact with the felt.

In accordance with an advantageous embodiment of the method in accordance with the invention, a so-called spectra membrane is used for dewatering the web, with this spectra membrane preferably being used together with a conventional, in particular woven, screen.

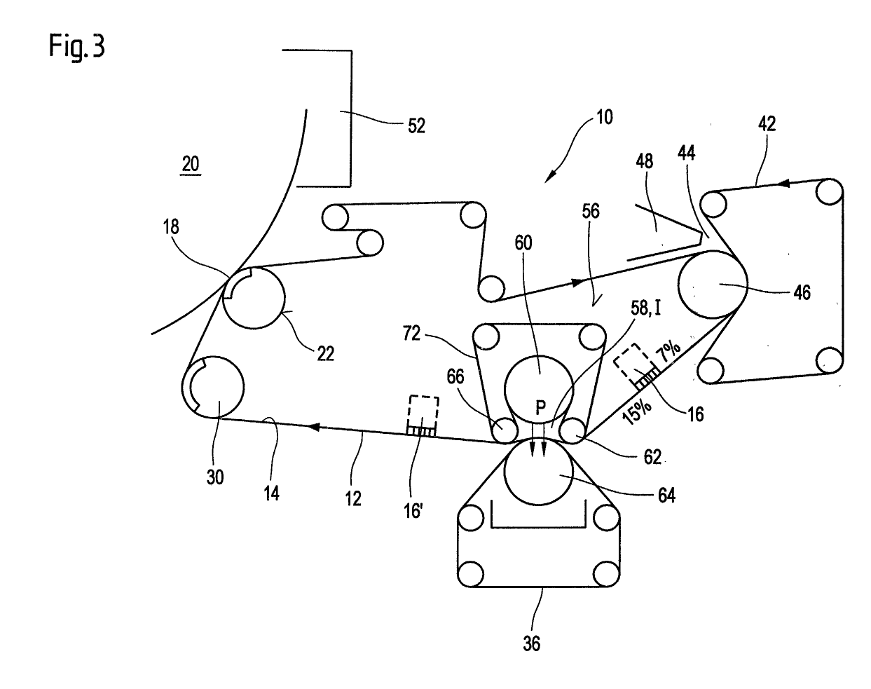

Such a spectra membrane can in particular be designed and manufactured as is described in GB 2 305 156 A in connection with its FIG. 3 and in GB 2 235 705 B. The two publications just cited are hereby incorporated in the present application by reference.

The spectra membrane can therefore in particular be a membrane with a regular, non-woven mesh structure through which suction is possible. It can be provide with spun reinforcement threads which extend through the mesh structure in the web running direction (cf. in particular FIG. 3 of GB 2 305 156 A). This spectra membrane can in particular be a porous, reinforced membrane made from a composite, with spun threads or yarns extending in the machine direction forming the reinforcing elements and the surrounding matrix material including fluid passages, completely encapsulating the spun threads and connecting them to one another, spun thread for spun thread, to produce the non-woven spectra membrane (cf. in particular GB 2 235 705 B). In other respects, the spectra membrane can also in particular be designed and manufactured as is described in GB 2 305 156 A and GB 2 235 705 B.

Since the spectra membrane has a relatively coarse mesh, it is of advantage for it to preferably be used together with a conventional, in particular woven, screen. The distribution of the through-air is thus substantially improved and the drying is thus more uniform. This function becomes necessary not least when the surface of the through-flow cylinder only has an open area of <25% and large land areas are provided between the holes.

Such a spectra membrane can therefore in particular be used instead of the felt with a foamed layer. An anti-rewetting effect is utilized for dewatering instead of the capillary effect.

In accordance with a further advantageous alternative embodiment of the method in accordance with the invention a so-called anti-rewetting membrane or anti-rewetting fabric (or anti-rewet fabric) can also be used for dewatering the web.

The anti-rewetting membrane can in particular include the following:

at least one air distribution fabric layer, with such an air distribution fabric layer being configured for a coming into contact with the fiber web; and

a perforated film layer, which can consist of a polyester film or of a plastic film, wherein the perforated film layer has a first film side and a second film side and wherein the first film side can be laminated or applied to the relevant air distribution fabric layer. The perforated film layer can also be brought into direct contact with the paper web, with in this case, however, the positive effect being substantially lower. A respective air distribution fabric layer can include a plain weave (linen bond) or a fabric of a plurality of floating threads (multi-float weave, multi-strand bond; weave type). A respective air distribution fabric layer can include a fabric consisting of a plurality of floating threads (multi-float weave). The perforated film layer can include a series of perforation holes, with each set of perforation holes, which are spaced apart as closely as possibly, being separated from the others by a perforation space, with each air distribution fabric layer having an associated kind of material bond or weave and with the kind of material bond or weave having an interval distance of the bond kind or weave kind which is equal to or larger than the perforation space. The bond kind or weave kind interval distance can in particular also be larger than the perforation space. The perforation film layer can have a series of perforation holes, with the perforation film layer being able to have, for example, approximately 40,000 holes per m². The perforation film layer can in particular have a series of perforation holes, with the perforation film layer being able to have, for example, less than approximately 200,000 holes per m². The perforation film layer can have an open area, for example, in the range from approximately 1% to approximately 30% and preferably in a range from, for example, approximately 5% to approximately 15%. The perforated film layer can, for example, have a thickness of less than approximately 0.04 inches, with the thickness, for example, being less than approximately 0.005 inches. Moreover, the anti-rewetting membrane can, for example, include a first air distribution fabric layer and a second air distribution fabric layer, with the first air distribution fabric layer being able to be laminated or applied to the first film side and with the second air distribution fabric layer being able to be laminated or applied to the second film side. A respective air distribution material layer can, for example, be manufactured of satin material.

The anti-rewetting membrane can be used together with a conventional, in particular woven, screen or also without an additional screen or the like.

The method in accordance with the invention thus also provides the advantage that substantially higher dry contents of the tissue web are achieved even upstream of the dryer cylinder, in particular the Yankee cylinder, by avoiding the rewetting as a consequence of the embodiment of the method in accordance with the invention and indeed with the high specific bulk which is important for tissue. It is of particular advantage if the web is wet imprinted at a low dry content upstream of a dewatering unit or dewatering apparatus.

A pressure difference of the compressed gas between the two sides of the web is absolutely necessary for the wet imprinting. The use of a suction box is particularly advantageous.

As already mentioned, the anti-rewetting membrane does not necessarily have to be used together with a conventional, in particular woven, screen, since such an anti-rewetting membrane also effects a good distribution of the through-medium.

A clothing, e.g. a screen, felt with a foamed layer, a spectra membrane—preferably together with a conventional, in particular woven, screen—or an anti-rewetting membrane with or without a conventional, in particular woven, screen, can be guided together with an imprinting band and a fiber web interposed therebetween around a suction roll, with the clothing preferably being in contact with the suction roll.

The clothing with a foamed layer, spectra membrane, preferably together with a conventional, in particular woven, screen or an anti-rewetting membrane with or without a conventional, in particular woven, screen, can, for example, wrap a suction roll with a diameter from, for example, approximately 2 to 3 m, or a plurality of suction rolls with smaller diameters, preferably two suction rolls each with a diameter of, for example, approximately 2 m. The dwelling time of the web in the region of the suction roll or suction rolls should expediently be larger than approximately 0.15 s and less than approximately 0.40 s.

The relevant suction roll can have, for example, a vacuum applied to its lower side or a suction roll with an associated siphon extractor can be used. In particular with a lower diameter, the water can, for example, also be spun into a channel by centrifugal force. The water can in particular also be blown off by means of an air knife.

Dewatering while utilizing the capillary effect is admittedly already described in U.S. Pat. No. 5,701,682, but the relevant capillary element is here a part of the suction roll, which is disadvantageous for the conditioning of the capillary element.

Despite the utilization of the capillary effect or of the anti-rewetting effect for the dewatering, the suction device can in particular have a hood standing under overpressure associated with it to support the underpressure effect of the suction device and to be able to work at higher temperatures (e.g. ˜140° C.).

In accordance with a further preferred embodiment of the method in accordance with the invention, to drive out water by means of gas pressure, the fiber web is guided together with an imprinting band at least once, preferably twice, through a pressure space which is bounded by at least four rolls arranged in parallel into which compressed gas is fed. In this connection, the fiber web is preferably guided together with the imprinting band between membranes through the pressure space, with preferably an air distribution membrane and an anti-rewetting membrane being used. The basic principle of such a displacement press in which the water in the fiber web is displaced by air, is described, for example, in DE 19946972.

A method in accordance with the invention for dewatering a fiber web, in particular a web of tissue or hygiene material, is characterized in that to drive out water by means of gas pressure, the fiber web is guided together with an imprinting band at least once, and preferably twice, through a pressure space which is bounded by at least four rolls arranged in parallel and into which a compressed gas is fed, and in that the fiber web is guided together with the imprinting band between membranes through the pressure space, with preferably an air distribution membrane and an anti-rewetting membrane being used.

The apparatus in accordance with the invention for manufacturing a fiber web, in particular a web of tissue or hygiene material, provided with a three-dimensional surface structure is characterized in that the fiber web is pressed at a dry content of <25% onto an imprinting band, e.g. by suction, by means of a first printing field and is thereby pre-imprinted, and is subsequently once more pressed onto an imprinting band by means of a further pressure field for further dewatering and drying in order to fix the three-dimensional surface structure and strength.

Preferred embodiments of this apparatus in accordance with the invention are set forth in the dependent claims.

An apparatus in accordance with the invention for dewatering a fiber web, in particular a web of tissue or hygiene material, is characterized in that, to drive out water by means of gas pressure, the fiber web is guided together with an imprinting band at least once, and preferably twice, through a pressure space which is bounded by at least four rolls arranged in parallel and into which a compressed gas can be led, and in that the fiber web is guided together with the imprinting band and between membranes through the pressure space, with preferably an air distribution membrane and an anti-rewetting membrane being used.

The invention can be used in particular with crescent formers, duo formers, C wrap formers, S wrap formers and in the manufacture of multi-layer and multi-ply tissue.

The invention will be described in more detail in the following with reference to embodiments and to the drawing, in which are shown:

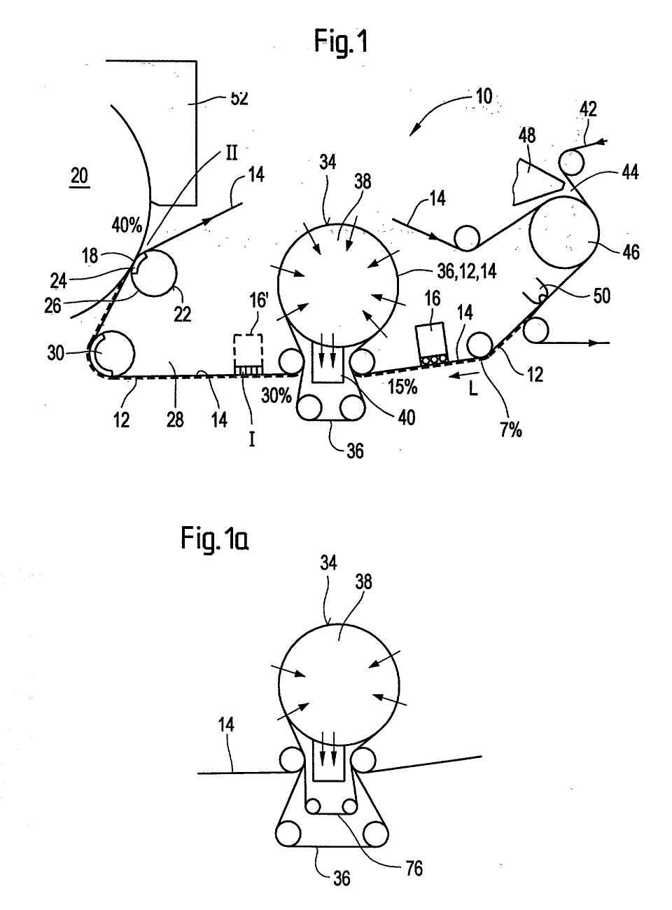

FIG. 1 a schematic part representation of an embodiment of an apparatus for manufacturing a fiber web provided with a three-dimensional surface structure in which a dewatering apparatus is additionally provided in which the capillary action of a felt with a foamed layer, the action of a spectra membrane, preferably with an associated conventional, in particular woven, screen, or the action of a rewetting membrane with or without a conventional, in particular woven, screen is utilized for dewatering;

FIG. 1a a schematic representation of the dewatering apparatus with a spectra membrane or a rewetting membrane, optionally with an additional conventional screen;

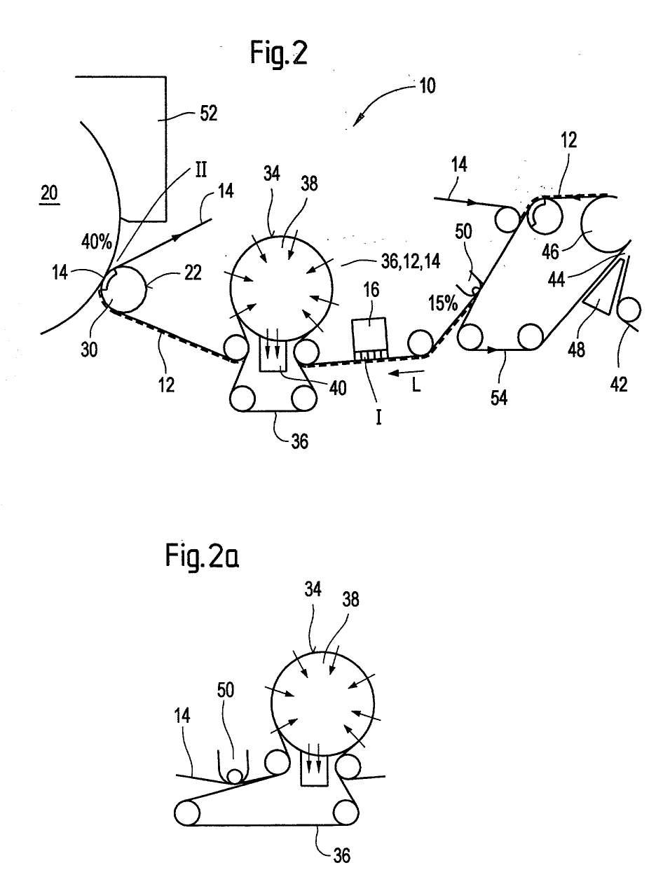

FIG. 2 a schematic part representation of a further embodiment of an apparatus for manufacturing a fiber web provided with a three-dimensional surface structure in which a dewatering apparatus is additionally provided in which the capillary action of a felt with a foamed layer, the action of a spectra membrane, preferably with an associated conventional, in particular woven, screen, or the action of a rewetting membrane with or without a conventional, in particular woven, screen is utilized for dewatering;

FIG. 2a a variant with a pick-up or separation element for a better web transfer;

FIG. 3 a schematic part representation of an embodiment of an apparatus for manufacturing a fiber web provided with a three-dimensional surface structure in which a displacement press is additionally provided;

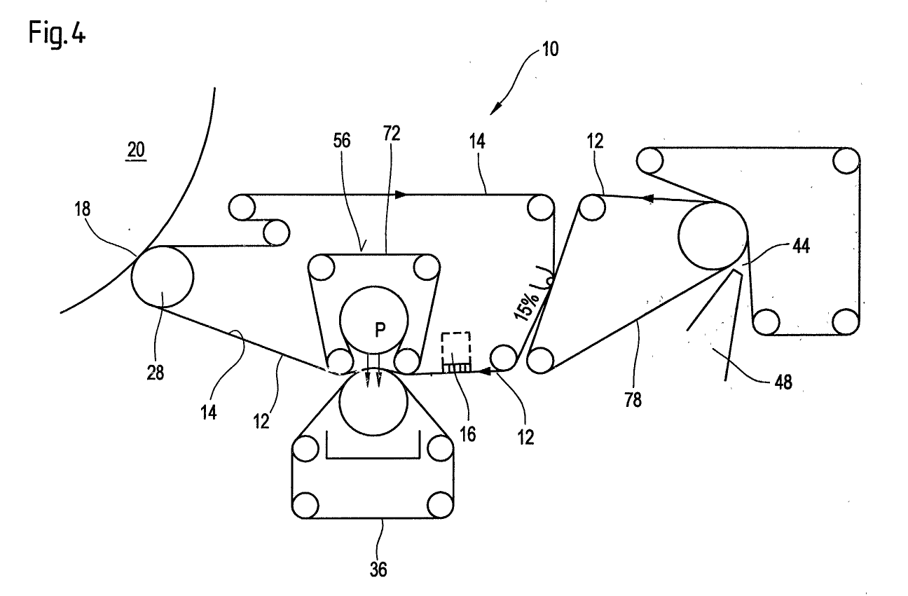

FIG. 4 a schematic part representation of a further embodiment with a displacement press;

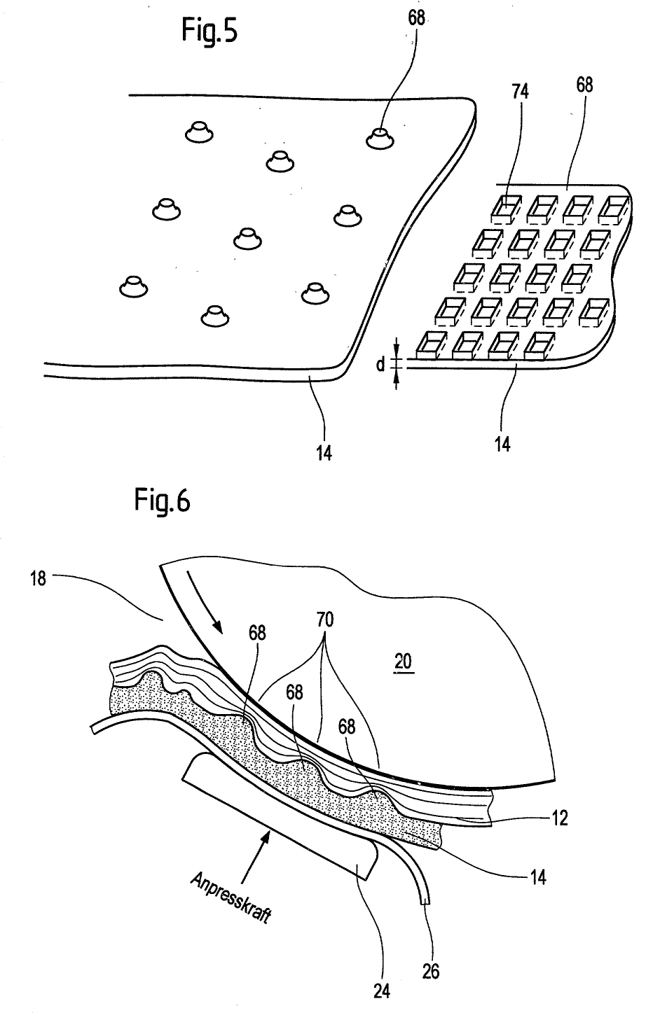

FIG. 5 a schematic part representation of an imprinting band with a smaller areal proportion of raised zones in comparison with the areal proportion of recessed zones; and

FIG. 6 a schematic section through a press nip through which the imprinting band shown in FIG. 6 is led together with the fiber web.

FIG. 1 shows in a schematic part representation an embodiment of an apparatus 10 for manufacturing a fiber web 12 (cf. also FIG. 6) provided with a three-dimensional surface structure in which a dewatering apparatus 34 is provided in which, for example, the capillary action of a felt 36 with a foamed layer is utilized for dewatering. In this connection, the foam coating can in particular be selected such that pores result in a range from approximately 3 to approximately 6 μm.

Instead of a felt with a foamed layer, a so-called spectra membrane can, for example, also be used, with this spectra membrane preferably being used together with a conventional, in particular woven, screen. Alternatively, a so-called anti-rewetting membrane can also be used. Such an anti-rewetting membrane can be used together with a conventional, in particular woven, screen or also without such an additional screen or the like.

In the present case, the felt 36 with a foamed layer is guided together with an imprinting band 14 and a fiber web 12 interposed therebetween about a larger suction roll 38, with the felt 36 preferably being in contact with the suction roll 38. The suction roll 38 wrapped, for example, by the felt 36 with a foamed layer can, for example, have a diameter from approximately 2 to approximately 3 m. The suction roll 38 can have a vacuum applied to its lower side. Generally, a siphon extractor can also be associated with the suction roll 38. The relevant means are designated by “40” in FIG. 1.

In the forming region, at least one dewatering screen with zonally different screen permeability can be provided.

In the present case, a former with two peripheral dewatering bands 14, 42 is provided, with the inner band 14 simultaneously serving as the imprinting band. The two dewatering bands 14, 42 run together while forming a pulp run in gap and are guided over a forming element 46 such as in particular a forming roll.

In the present case, the imprinting band 14 is formed by the inner band of the former which comes into contact with the forming element 46. The outer band 42, which does not come into contact with the forming element 46, can in particular be provided as a dewatering screen with zonally different screen permeability.

The fiber suspension is introduced into the pulp run in gap 44 by means of a head box 48. A pick-up element or separation element 50 is provided downstream of the forming element 46 and the web is held on the imprinting band 14 by this during the separation from the dewatering band 42. A suction element 16 (solid representation) is preferably provided upstream of the apparatus 34 with capillary action or, for example, of the action of a spectra membrane or of an anti-rewetting membrane with or without an additional conventional screen and the fiber web 12 is pressed onto the imprinting band 14 by this. This suction element can, however, also be arranged between the apparatus 34 with, for example, capillary action, etc. and the suction device or suction roll 30 (broken line representation 16′).

The fiber web 12 and the imprinting band 14 are guided through the press nip 18 formed between a dryer cylinder 20 and a shoe press unit 22. The shoe press unit 22 includes a flexible band 26 guided over a press shoe 24 in the region of the press nip 18. The imprinting band 14 and the fiber web 12 are guided upstream of the press nip about a suction device 30 which can in particular be a suction roll. The dryer cylinder 20 can in particular be a Yankee cylinder. In this connection, a dryer hood 52 can be associated with this dryer cylinder 20.

In the present example, the dry content of the fiber web upstream of the dewatering apparatus 34 amounts to approximately 10 to approximately 25%; in the region downstream of this apparatus 34, for example approximately 30 to approximately 40%.

The fiber web 12 is therefore in particular pressed, e.g. sucked, at a dry content of <25%, in particular <15% and preferably <10%, onto the imprinting band or structured band 14 by means of a first pressure field I in the region of the suction element 16 or 16′ and is thereby pre-imprinted, in particular, and is subsequently once more pressed onto the imprinting band 14 by means of a further pressure field II in the region of the press nip 18 for further dewatering and drying in order to fix the three-dimensional structure and strength. In this connection, in particular an imprinting screen can be provided as the imprinting band 14.

FIG. 1a shows in a schematic representation the dewatering apparatus 34 with a spectra membrane 36 which is used in the present example together with a conventional, in particular woven, screen 76. In this FIG. 1a, a vacuum producing apparatus such as in particular the through-air cylinder or the large suction roll 38 and the imprinting band or imprinting screen 14 can also again be recognized.

The embodiment shown in FIG. 2 initially differs from that in accordance with FIG. 1 in that the fiber web 12 is taken over by the imprinting band 14 from an inner band 54 of the former. In the present case, for example, this inner band 54 or the outer band 42 of the former can again be provided as a dewatering screen with zonally different screen permeability. The two peripheral dewatering bands 42, 54 again run together while forming a pulp run in gap 44, with them again being guided via a forming element 46 such as in particular a forming roll. The pulp run in gap 44 is again charged with fiber suspension by means of a head box 48. In contrast to the embodiment in accordance with FIG. 1, the fiber suspension is, however, supplied from below in the present case.

A pick-up element or separation element is again provided within the loop of the imprinting band 14 and the fiber web 12 is held on the imprinting band by this on the separation from the inner band 54 of the former.

The suction element 16 provided within the loop of the imprinting band 14 is arranged upstream of the dewatering apparatus 34 with a capillary action or, for example, of the action of a spectra membrane or of an anti-rewetting membrane with or without an additional, conventional screen, with generally, however, an arrangement downstream of this apparatus 34 also being possible.

The dry content of the fiber web in the present example amounts to approximately 10 to approximately 25% in the region of the pick-up element 50, approximately 15 to approximately 30% in the region upstream of the dewatering apparatus 34 and approximately 35 to approximately 45% in the region downstream of this apparatus 34. In this case, a pressing roll 28 can be provided instead of a shoe press unit.

The deflection roll provided adjacent to the dewatering apparatus 34 can also be a suction roll for a better web transfer.

Another variant with a pick-up element or a separation element for a better web transfer is shown in FIG. 2a.

In another respect, this embodiment can have at least substantially the same design as that in accordance with FIG. 1. Elements corresponding to one another are assigned the same reference numerals.

FIG. 3 shows in a schematic part representation an embodiment of the apparatus 10 in which a displacement press 56 is provided. In this connection, to drive out water by means of gas pressure, the fiber web 12 is guided together with the imprinting band 14 at least once through a pressure space 58 which is bounded by at least four rolls 60-66 arranged in parallel and into which compressed gas can be led. In this connection, the fiber web 12 is preferably guided through the pressure space 58 together with the imprinting band 14 and a membrane 72 as well as, for example, a spectra membrane or an anti-rewetting membrane 36.

In the present case, the imprinting band 14 forms the inner band of the former which in turn includes a forming element 46 such as in particular a forming roll in whose region the inner band provided as the imprinting band 14 and the outer band 42 run together while forming a pulp run in gap 44 which is charged with fiber suspension by means of a head box 48.

Subsequently to the air press 56, the fiber web 12 is again guided with the imprinting band 14 over a suction device 30, in particular a suction roll, and through the press nip 18 formed between a dryer cylinder 20, in particular a Yankee cylinder, and a shoe press unit 22. In the example shown, a dryer hood 52 is again associated with the dryer cylinder or Yankee cylinder 20.

In the present case, the first pressure field I, through which the fiber web 12 is pressed onto the imprinting belt 14 and correspondingly pre-imprinted at a dry content of <25%, in particular <15%, and preferably <10%, can be produced by the suction element 16.

FIG. 4 shows in a schematic part representation a further embodiment with a displacement or air press 56 with which pressing pressures can be produced as with the dewatering apparatus 34, in particular, however, also substantially higher pressures from, for example, up to 2, 3 or 10 bar depending on the paper type.

The embodiment initially differs from that in accordance with FIG. 3 in that the inner band 78 of the former is provided separately from the imprinting band 14 and the fiber web 12 is transferred to the imprinting band 14 from the inner band 78. Moreover, the fiber suspension is poured into the pulp run in gap 44 diagonally from the bottom to the top by means of the head box 48.

Furthermore, in the present example, the suction device 30 provided in the embodiment in accordance with FIG. 3 is omitted. Instead of the shoe press unit 22, a conventional press roll 28 is provided, for example, which forms the press nip 18 with the dryer cylinder 20, in particular the Yankee cylinder.

The membrane 68 can, for example, be a fine membrane and the membrane 36 can, for example, be a coarse-mesh spectra membrane or an anti-rewetting membrane.

In another respect, this embodiment shown in FIG. 4 can again have at least substantially the same design as that in FIG. 3.

As can be recognized, for example, with reference to FIGS. 5 and 6, the respective imprinting band 14, e.g. imprinting screen (cf. in particular the left hand part of FIG. 5) or imprinting membrane (cf. in particular the right hand part of FIG. 5), guided through the press nip 18 can be structured such that for this imprinting band 14 a smaller areal proportion of raised or closed zones 68 results in comparison with the areal proportion of recessed zones or holes 74 and accordingly a smaller areal proportion of the fiber web 12 is pressed in the press nip 18.

In this connection, the areal proportion of raised or closed zones 68 can in particular be ≦40% and can preferably lie in a range from approximately 20 to approximately 30% and in particular at approximately 25%.

The raised zones 68 and the recessed zones can result, for example, due to offsets, i.e. due to intersection points of picks and ends, of a screen fabric. In the case of the pressing membrane reproduced in the right hand part of FIG. 5, a corresponding structure arises due to the holes 74.

FIG. 5 shows a schematic part representation of a corresponding imprinting band 14, e.g. imprinting felt or imprinting membrane, with a smaller areal proportion of raised or closed zones 68 in comparison with an areal proportion of recessed zones or holes 74.

The thickness d of the imprinting membrane shown in the right hand part of FIG. 5 can amount, for example, approximately to 1 to approximately 3 mm. The open area can in particular be larger than 50% and expediently larger than 60% and preferably lie in a region from approximately 70% to approximately 75%. The membrane expediently consists of a material resistant to the fiber chemistry. It can consist, for example, of polyurethane.

FIG. 6 shows a schematic section through a press nip 18 through which the imprinting band 14 shown in FIG. 5 is guided together with the fiber web 12. In this connection, this imprinting band 14 is in contact with the flexible band 26 of the shoe press unit which is guided in the region of the press nip 18 over a press shoe 24 via which the desired pressing force can be applied.

The fiber web 12 contacts the dryer cylinder 20, preferably a Yankee cylinder.

Moreover, in FIG. 6, the pressing zones 70 resulting as a consequence of the raised zones 68 can be recognized.

The fiber web 12 is already imprinted upstream of the nip. As can be recognized with reference to FIG. 6, it already contacts the imprinting band upstream of the nip.

### Reference Numeral List

10 apparatus

12 fiber web

14 imprinting band

16 suction element

18 press nip

20 dryer cylinder, Yankee cylinder

20′ surface

22 opposing element, shoe press unit

24 press shoe

26 flexible band, flexible roll jacket

28 pressing roll

30 suction device, suction roll

34 dewatering apparatus with capillary action or anti-rewetting action

36 felt with foamed layer, spectra membrane or anti-rewetting membrane

38 large suction roll

40 vacuum, siphon extractor

42 dewatering band

44 pulp run in gap

46 forming element, forming roll

48 head box

50 pick-up element or separation element

52 dryer hood

54 inner dewatering screen

56 air press

58 pressure space

60 roll

62 roll

64 roll

66 roll

68 raised zones

70 pressing zones

72 membrane

74 holes

76 conventional screen

78 inner band

d thickness

L web running direction

I first pressure field

II further pressure field

1. A method for manufacturing a fiber web, in particular a web of tissue or hygiene material, provided with a three-dimensional surface structure in which the fiber web is pressed at a dry content of <25% onto an imprinting band by means of a first pressure field and is thereby pre-imprinted and is subsequently once more pressed onto an imprinting band by means of a further pressure field for further dewatering and drying in order to fix the three-dimensional surface structure and strength.

2. A method in accordance with claim 1, characterized in that an imprinting screen is used as the imprinting band.

3. A method in accordance with claim 1, characterized in that an imprinting membrane is used as the imprinting band.

4. A method in accordance with any one of the preceding claims, characterized in that the fiber web is pre-imprinted downstream of the forming region.

5. A method in accordance with any one of the preceding claims, characterized in that the fiber web is formed on the imprinting band used for imprinting.

6. A method in accordance with any one of the preceding claims, characterized in that the fiber web is transferred onto the imprinting band used for pre-imprinting.

7. A method in accordance with any one of the preceding claims, characterized in that the same imprinting band is used for pre-imprinting and for fixing the surface structure.

8. A method in accordance with any one of the preceding claims, characterized in that at least the first pressure field is produced by means of a suction element arranged at the side of the imprinting band remote from the fiber web to suck the fiber web into the surface structure of the imprinting band.

9. A method in accordance with claim 8, characterized in that a wet suction box is used as the suction element.

10. A method in accordance with any one of the preceding claims, characterized in that the fiber web is pressed gently in the further pressure field, i.e. preferably over a stretch extended in the web running direction.

11. A method in accordance with any one of the preceding claims, characterized in that the further pressure field is produced by means of a press nip.

12. A method in accordance with claim 11, characterized in that the press nip forming the further pressure field is produced between a dryer cylinder and an opposing element, with the fiber web guided through the press nip being in contact with the surface of the dryer cylinder and contacting the imprinting band with its other side.

13. A method in accordance with claim 12, characterized in that a Yankee cylinder is used as the dryer cylinder.

14. A method in accordance with claim 12 or claim 13, characterized in that a shoe press unit is used as the opposing element interacting with the dryer cylinder and includes a flexible band guided via a press shoe in the region of the press nip.

15. A method in accordance with claim 14, characterized in that a shoe pressing roll provided with a flexible roll jacket is used as the shoe press unit.

16. A method in accordance with claim 12 or claim 13, characterized in that a pressing roll or a suction pressing roll is used as the opposing element interacting with the dryer cylinder.

17. A method in accordance with any one of the preceding claims, characterized in that the pre-imprinted fiber web is dried on the dryer cylinder; in that the fiber web is creped and/or in that the fiber web is subsequently wound up.

18. A method in accordance with any one of the preceding claims, characterized in that the dry content at which the fiber web is pre-imprinted and/or the dry content at which the three-dimensional surface structure is fixed is respectively selected at <25%, in particular <15%, and preferably <10%.

19. A method in accordance with any one of the preceding claims, characterized in that a suction device is used between the suction element producing the first pressure field and the press nip producing the further pressure field; and in that the fiber web is guided together with an imprinting band both over the suction device and through the press nip.

20. A method in accordance with claim 19, characterized in that the suction device has a curved surface and the fiber web and the imprinting band are guided over this curved area.

21. A method in accordance with claim 20, characterized in that a suction roll is used as the suction device.

22. A method in accordance with any one of the preceding claims, characterized in that a hood standing under overpressure is associated with the suction device to support the underpressure action of the suction device.

23. A method in accordance with any one of the preceding claims, characterized in that the length of the press nip of the shoe press including the dryer cylinder and the shoe press unit observed in the web running direction is selected to be larger than a value of approximately 80 mm and the shoe press is designed such that a pressure profile results over the press nip length with a maximum pressing pressure which is smaller than or equal to a value of approximately 2.5 MPa.

24. A method in accordance with any one of the preceding claims, characterized in that at least one dewatering screen with a zonally different screen permeability is used in the forming region.

25. A method in accordance with claim 24, characterized in that a former is used with two circulating dewatering bands which run together while forming a pulp run-in gap and are guided over a forming element such as in particular a forming roll; and in that a dewatering screen with a zonally different screen permeability is used as an outer band not coming into contact with the forming element and/or as an inner band.

26. A method in accordance with claim 25, characterized in that an imprinting band is used as the inner band and a dewatering screen with zonally different screen permeability is preferably used as the outer band.

27. A method in accordance with claim 26, characterized in that the fiber web is preferably taken over from the inner band by an imprinting band.

28. A method in accordance with any one of the preceding claims, characterized in that an imprinting band, e.g. an imprinting screen or an imprinting membrane, is guided through the press nip and is structured such that for this imprinting band a smaller areal proportion of raised or closed zones results in comparison with the areal proportion of recessed zones or holes and correspondingly a smaller areal proportion of the fiber web is pressed in the press nip.

29. A method in accordance with claim 28, characterized in that an imprinting band is used in which the areal proportion of raised or closed zones is ≦40% and preferably lies in a range from approximately 20% to approximately 30%, and in particular at approximately 25%.

30. A method in accordance with claim 28 or claim 29, characterized in that an imprinting band is used in which the raised zones and the recessed zones result from offsets, i.e. from intersection points of picks and ends, of a screen fabric.

31. A method in accordance with any one of the preceding claims, characterized in that at least one felt with a foamed layer is used for dewatering the web.

32. A method in accordance with claim 31, characterized in that the foam coating is selected such that pores results in a range from approximately 3 to approximately 6 μm.

33. A method in accordance with any one of claims 1 to 30, characterized in that a so-called spectra membrane is used for dewatering the web, with this spectra membrane preferably being used together with a conventional, in particular a woven, screen.

34. A method in accordance with any one of claims 1 to 30, characterized in that a so-called anti-rewetting membrane is used for dewatering the web.

35. A method in accordance with claim 34, characterized in that the anti-rewetting membrane is used together with a conventional, in particular a woven, screen.

36. A method in accordance with claim 34, characterized in that the anti-rewetting membrane is used without an additional screen or the like.

37. A method in accordance with any one of the preceding claims, characterized in that a clothing, e.g. a screen, felt with a foamed layer, a spectra membrane preferably together with a conventional, in particular woven, screen or an anti-rewetting membrane with or without a conventional, in particular woven, screen, is guided together with an imprinting band and a fiber web interposed therebetween about at least one suction roll, with the clothing preferably being in contact with the suction roll.

38. A method in accordance with any one of claims 31 to 37, characterized in that the clothing with a foamed layer, spectra membrane preferably together with a conventional, in particular woven, screen or an anti-rewetting membrane with or without a conventional, in particular woven, screen, wraps a suction roll with a diameter from approximately 2 to approximately 3 m or a plurality of suction rolls with smaller diameters, preferably two suction rolls with a diameter from, for example, approximately 2 m in each case.

39. A method in accordance with any one of claims 31 to 38, characterized in that the suction roll has a vacuum applied to its lower side.

40. A method in accordance with any one of claims 31 to 38, characterized in that a suction roll with an associated siphon extractor is used or the water is spun into a channel by centrifugal force.

41. A method in accordance with any one of the preceding claims, characterized in that the water is blown off by means of an air knife.

42. A method in accordance with any one of the preceding claims, characterized in that, to drive out water by means of gas pressure, the fiber web is guided together with an imprinting band at least once, and preferably twice, through a pressure space which is bounded by at least four rolls arranged in parallel and into which a compressed gas is led.

43. A method in accordance with claim 42, characterized in that the fiber web is guided together with the imprinting band between membranes through the pressure space, with preferably an air distribution membrane and an anti-rewetting membrane being used.

44. A method in accordance with any one of the preceding claims, characterized in that the thickness of the imprinting membrane amounts to approximately 1 to approximately 3 mm and/or in that the open area of this imprinting membrane is larger than 50%, and expediently larger than 60%, and preferably lies in a range from approximately 70% to approximately 75%.

45. A method for dewatering a fiber web, in particular a web of tissue or hygiene material, characterized in that, to drive out water by means of gas pressure, the fiber web is guided together with an imprinting band at least once, and preferably twice, through a pressure space which is bounded by at least four rolls arranged in parallel and into which a compressed gas is led and in that the fiber web is guided together with the imprinting band between membranes through the pressure space, with preferably an air distribution membrane and an anti-rewetting membrane being used.

46. An apparatus (10) for manufacturing a fiber web (12), in particular a web of tissue or hygiene material, provided with a three-dimensional surface structure in which the fiber web (12) is pressed at a dry content of <25% onto an imprinting band (14) by means of a first pressure field (I) and is thereby pre-imprinted and is subsequently once more pressed onto an imprinting band (14) by means of a further pressure field (II) for further dewatering and drying in order to fix the three-dimensional surface structure and strength.

47. An apparatus in accordance with claim 46, characterized in that an imprinting screen is provided as the imprinting band (14).

48. An apparatus in accordance with claim 46, characterized in that an imprinting membrane is provided as the imprinting band (14).

49. An apparatus in accordance with claim 47 or claim 48, characterized in that the fiber web (12) is imprinted downstream of the forming region.

50. An apparatus in accordance with any one of the preceding claims, characterized in that the fiber web (12) is formed on the imprinting band (14) used for imprinting.

51. An apparatus in accordance with any one of the preceding claims, characterized in that the fiber web (12) is transferred onto the imprinting band (14) used for pre-imprinting.

52. An apparatus in accordance with any one of the preceding claims, characterized in that the same imprinting band (14) is provided for pre-imprinting and for fixing the surface structure.

53. An apparatus in accordance with any one of the preceding claims, characterized in that at least the first pressure field (I) is produced by means of a suction element (16) arranged at the side of the imprinting band (14) remote from the fiber web (12) to suck the fiber web (12) into the surface structure of the imprinting band (14).

54. An apparatus in accordance with claim 53, characterized in that a wet suction box is provided as the suction element (14).

55. An apparatus in accordance with any one of the preceding claims, characterized in that the fiber web (12) is pressed gently in the further pressure field (II), i.e. preferably over a stretch extended in the web running direction (L).

56. An apparatus in accordance with any one of the preceding claims, characterized in that the further pressure field (II) is produced by means of a press nip (18).

57. An apparatus in accordance with claim 56, characterized in that the press nip (18) forming the further pressure field (II) is provided between a dryer cylinder (20) and an opposing element (22), with the fiber web (12) guided through the press nip (18) being in contact with the surface (20′) of the dryer cylinder (20) and contacting the imprinting band with its other side.

58. An apparatus in accordance with claim 57, characterized in that a Yankee cylinder is provided as the dryer cylinder (20).

59. An apparatus in accordance with claim 57 or claim 58, characterized in that a shoe press unit is provided as the opposing element (22) interacting with the dryer cylinder (20) and includes a flexible band (26) guided via a press shoe (24) in the region of the press nip (18).

60. An apparatus in accordance with claim 59, characterized in that a shoe pressing roll provided with a flexible roll jacket (26) is provided as the shoe press unit.

61. An apparatus in accordance with claim 57 or claim 58, characterized in that a suction press roll with a soft liner and/or a low pressing pressure is provided as the opposing element (22) interacting with the dryer cylinder (20).

62. An apparatus in accordance with claim 57 or claim 58, characterized in that a pressing roll or suction pressing roll is provided as the opposing element (22) interacting with the dryer cylinder (20).

63. An apparatus in accordance with any one of the preceding claims, characterized in that means are provided to dry the pre-imprinted fiber web (12) on the dryer cylinder (20), to crepe the fiber web and/or to subsequently wind up the fiber web (12).

64. An apparatus in accordance with any one of the preceding claims, characterized in that the dry content at which the fiber web (12) is pre-imprinted and/or the dry content at which the three-dimensional surface structure is fixed, is in each case <25%, in particular <15%, and preferably <10%.

65. An apparatus in accordance with any one of the preceding claims, characterized in that a suction device (30) is provided between the suction element (16) producing the first pressure field (I) and the press nip (18) producing the further pressure field (II); and in that the fiber web (12) is guided together with an imprinting band (14) both over the suction device and through the press nip (18).

66. An apparatus in accordance with claim 65, characterized in that the suction device (30) has a curved surface and the fiber web (12) and the imprinting band (14) are guided over this curved surface.

67. An apparatus in accordance with claim 66, characterized in that a suction roll is provided as the suction device (30).

68. An apparatus in accordance with any one of the preceding claims, characterized in that a hood standing under overpressure is associated with the suction device (30) to support the underpressure effect of the suction device (30).

69. An apparatus in accordance with any one of the preceding claims, characterized in that the length of the press nip (18) of the shoe press including the dryer cylinder (20) and the shoe press unit (22) observed in the web running direction (L) is larger than a value of approximately 80 mm and the shoe press is designed such that a pressure profile results over the press nip length with a maximum pressing pressure which is smaller than or equal to a value of approximately 2.5 MPa.

70. An apparatus in accordance with any one of the preceding claims, characterized in that at least one dewatering screen (42, 54) with zonally different screen permeability is provided in the forming region.

71. An apparatus in accordance with claim 70, characterized in that a former with two circulating dewatering bands (14, 42) is provided, which run together while forming a pulp run-in gap (44) and are guided over a forming element (46) such as in particular a forming roll; and in that a dewatering screen with zonally different screen permeability is provided as an outer band (42) not coming into contact with the forming element (46) and/or as an inner band (54).

72. An apparatus in accordance with claim 71, characterized in that an imprinting band (14) is provided as the inner band and a dewatering screen with zonally different screen permeability is preferably provided as an outer band (42).

73. An apparatus in accordance with claim 71, characterized in that the fiber web (12) is preferably taken over from the inner band (54) by an imprinting band.

74. An apparatus in accordance with any one of the preceding claims, characterized in that an imprinting band (14), e.g. an imprinting screen or imprinting membrane, is guided through the press nip (18) and is structured such that for this imprinting band (14) a smaller areal proportion of raised or closed zones (68) results in comparison with the areal proportion of recessed zones or holes and a smaller areal proportion of the fabric web (12) is correspondingly pressed in the press nip (18).

75. An apparatus in accordance with claim 74, characterized in that an imprinting band (14) is provided in which the areal proportion of raised or closed zones (68) is ≦40% and preferably lies in a range from approximately 20% to approximately 30% and in particular at approximately 25%.

76. An apparatus in accordance with claim 74 or 75, characterized in that an imprinting band (14) is provided in which the raised zones (68) and the recessed zones result from offsets, i.e. from intersection points of picks and ends, of a screen fabric.

77. An apparatus in accordance with any one of the preceding claims, characterized in that at least one felt (36) with a foamed layer is provided for dewatering the web (12).

78. An apparatus in accordance with claim 77, characterized in that the foam coating is selected such that pores result in a range from approximately 3 to approximately 6 μm.

79. An apparatus in accordance with any one of claims 46 to 76, characterized in that a so-called spectra membrane is provided for dewatering the web, with this spectra membrane preferably being provided together with a conventional, in particular a woven, screen.

80. An apparatus in accordance with any one of claims 46 to 76, characterized in that a so-called anti-rewetting membrane is provided for dewatering the web.

81. An apparatus in accordance with claim 80, characterized in that the anti-rewetting membrane is provided together with a conventional, in particular woven, screen.

82. An apparatus in accordance with claim 80, characterized in that the anti-rewetting membrane is provided without an additional screen or the like.

83. An apparatus in accordance with any one of the preceding claims, characterized in that a clothing (36), e.g. a screen, a felt with a foamed layer, a spectra membrane preferably together with a conventional, in particular a woven, screen or an anti-rewetting membrane with or without a conventional, in particular woven, screen, is guided together with an imprinting band (14) and a fiber web (12) interposed therebetween about a suction roll (38), with the clothing (36) preferably being in contact with the suction role (38).

84. An apparatus in accordance with any one of claims 77 to 83, characterized in that the clothing (36) with a foamed layer, a spectra membrane preferably together with a conventional, in particular woven, screen, or an anti-rewetting membrane with or without a conventional, in particular woven screen, overcasts a suction roll (38) with a diameter of approximately 2 to approximately 3 m, or a plurality of suction rolls with smaller diameters, preferably two suction rolls with a diameter of, for example, approximately 2 m in each case.

85. An apparatus in accordance with any one of claims 77 to 83, characterized in that the suction roll (38) can have a vacuum applied to its underside.

86. An apparatus in accordance with any one of claims 77 to 84, characterized in that a suction roll (38) with an associated siphon extractor is provided or the water is spun into a groove by centrifugal force.

87. An apparatus in accordance with any one of the preceding claims, characterized in that an air knife is provided for blowing off water.

88. An apparatus. in accordance with any one of the preceding claims, characterized in that, to drive out water by means of gas pressure, the fiber web (12) is guided together with an imprinting band (14) at least once and preferably twice through a pressure space (58) which is bounded by at least four rolls (60-66) arranged in parallel and into which a compressed gas can be led.

89. An apparatus in accordance with claim 88, characterized in that the fiber web (12) is guided together with the imprinting band (14) and between membranes (72, 36) through the pressure space (58), with preferably an air distribution membrane (72) and an anti-rewetting membrane (36) being provided.

90. An apparatus in accordance with any one of the preceding claims, characterized in that the thickness of the imprinting membrane amounts to approximately 1 to approximately 3 mm and/or in that the open area of this imprinting membrane is larger than 50%, and expediently larger than 60%, and preferably lies in a range from approximately 70% to approximately 75%.

91. An apparatus for dewatering a fiber web, in particular a web of tissue or hygiene material, characterized in that, to drive out water by means of gas pressure, the fiber web (12) is guided together with an imprinting band (14) at least once, and preferably twice, through a pressure space (58) which is bounded by at least four rolls (60-66) arranged in parallel and into which a compressed gas can be led and in that the fiber web (12) is guided together with the imprinting band (14) between membranes (72, 36) through the pressure space, with preferably an air distribution membrane (72) and an anti-rewetting membrane (36) being provided.
